(19) United States
(12) Patent Application Publication
(10) Pub. No.: US 2011/0299646 A1
(43) Pub. Date: Dec. 8, 2011

(54) SYSTEM FOR SUPPORTING NUCLEAR POWER PLANT OPERATION

(75) Inventor: Masashi HIRAHATAKE, Tokyo (JP)

(73) Assignee: Mitsubishi Electric Corporation, Chiyoda-ku (JP)

(21) Appl. No.: 13/086,967

(22) Filed: Apr. 14, 2011

(30) Foreign Application Priority Data
Jun. 4, 2010 (JP) 2010-128819

(51) Int. Cl. G21C 7/36

(52) U.S. Cl. 376/217

(57) ABSTRACT

A system for supporting nuclear power plant operation includes an event data base that stores events corresponding to behaviors of the plant data. A countermeasure operation database stores operations corresponding to the events. An operation procedure database stores operation procedures that are required for the corresponding operations. An event discriminating section retrieves an event that occurs in a nuclear power plant from an event database so as to discriminate based on a behavior of plant data that is captured from the plant interface. A countermeasure retrieval section retrieves a countermeasure operation from the countermeasure operation database based on an event that is discriminated by the event discriminating section. A display control section displays an operation procedure that is required for performing the countermeasure operation on a display device. An operation confirmation section judges whether the countermeasure operation that is retrieved by the countermeasure retrieval section is completed.

### BACKGROUND OF THE INVENTION

1. Field of the Invention

The present invention relates to a system for supporting nuclear power plant operation that supports operation by displaying an operation procedure at a central control room where monitoring and operation are performed in a nuclear power plant.

2. Description of the Related Art

At a nuclear power plant, in order to operate a plant safely, it is required to perform operation corresponding to respective plant events in accordance with operation procedure manuals that are prepared according to safety provision, etc. Recently, control boards have been computerized. Owing to the computerization of control boards, operation procedure manuals have been computerized. As a result, functionality of operation procedure display system has been improved. In general, when an accident occurs at a plant, operation procedure manuals are used.

Therefore, operation procedure manuals are used as a guideline for dealing with the accident speedily and performing accurate plant operation. Consequently, improvement of functionality and operability has been further required.

Further, in the present operation procedure display system, from the viewpoint of visibility and operability, plant operation using operation procedure display system having limited size screen is not sufficient, and in order to improve the accuracy of plant operation, improvement of functionality and operability of operation procedure display system has been required.

Further, at a nuclear power plant, operation procedures are determined in accordance with safety provision, etc., and in general, operations that deviate from operation procedures that are described in operation procedure manuals are prohibited. Therefore, an action that is needed to perform plant operation such as showing an operation procedure manual and monitoring a screen increases load of an operator. Consequently, improvement of functionality and operability of operation procedure display system, and system that can accurately judge whether operation is performed in accordance with an operation procedure or not has been required.

For example, Patent Document 1 discloses a operation support system, that is, in a case where an alarm is issued, operation procedure document corresponding to the alarm is displayed, and when an operation corresponding to the document is completed, an operator inputs the check status or provides instructions to start up and execute an automatic recognition program so as to display recognition contents.

Further, Patent Document 2 and Patent Document 3 disclose an operation support system that automatically selects an action method corresponding to an event or an alarm that are stored in the apparatus so as to display the selected action method.
Patent Document 1: Japanese Patent Application Laid-Open No. 10-124136
Patent Document 2: Japanese Patent Application Laid-Open No. 2010-49519
Patent Document 3: Japanese Patent Application Laid-Open No. 2010-49532

### SUMMARY OF THE INVENTION

In a operation support system disclosed in Patent Document 1, the operation support system automatically confirms the state using an automatic confirmation program; however, an operator needs to start up an automatic confirmation program. Therefore, there is a problem such that certainty is not sufficient. Further, operation support systems disclosed in Patent Document 2 and Patent Document 3 automatically display an action method, however, the operation support systems do not check the completion of action. Therefore, the operation support systems disclosed in Patent Document 2 and Patent Document 3 can not be applied to a plant such as a nuclear power plant where operation in accordance with operation procedure manual is obligated.

The present invention has been implemented in order to solve the foregoing problems. An objective of the present invention is to provide an operation support system as follows. In a nuclear power plant where operation in accordance with operation procedure manual is obligated, in a case where an event that requires the action occurs, the operation support system according to the present invention displays the operation procedure corresponding to the event and can confirm the completion of operation in accordance with the operation procedure.

A system for supporting a nuclear power plant operation according to the present invention includes a display section in which plant data of the nuclear power plant is captured from a plant interface via a network so as to display an operation procedure manual of plant corresponding to the plant data; an event database that stores events corresponding to behaviors of the plant data; a countermeasure operation data base that stores operations corresponding to the events; an operation procedure data base that stores operation procedures that are required for the corresponding operations; an event discriminating section in which an event that occurs in the nuclear power plant is retrieved from an event data so as to discriminate based on a behavior of plant data that is captured from the plant interface; a countermeasure retrieval section in which a countermeasure operation is retrieved from a countermeasure operation data base based on an event that is discriminated by an event discriminating section; a display control section in which an operation procedure that is required for performing a countermeasure operation and is retrieved by the countermeasure retrieval section is sequentially read out so as to display the operation procedure on a display device; and an operation confirmation section which judges whether the countermeasure operation that is retrieved is completed or not.

The system for supporting nuclear power plant operation according to the present invention includes a display control section in which an operation procedure that is required for performing countermeasure operation is sequentially read out from an operation procedure database so as to display the operation procedure on a display section, in a case where an event that requires countermeasure occurs; and an operation confirmation section that discriminates whether a countermeasure operation is completed or not. Consequently, the system for supporting operation that can securely confirm the completion of operation in accordance with an operation procedure corresponding to an event that occurred can be obtained.

### BRIEF DESCRIPTION OF THE DRAWINGS

FIG. 1 is a block diagram illustrating a configuration of system for supporting nuclear power plant operation according to Embodiment 1 of the present invention;

FIG. 2 is a flow sheet illustrating the outline of operation of a system for supporting nuclear power plant operation according to Embodiment 1 of the present invention;

FIG. 3 is a diagram showing an example of content of data base of behavior of system for supporting nuclear power plant operation according to Embodiment 1 of the present invention;

FIG. 4 is a diagram showing an example of content of data base of event of system for supporting nuclear power plant operation according to Embodiment 1 of the present invention;

FIG. 5 is a diagram showing an example of content of data base of countermeasure operation data base of system for supporting nuclear power plant operation according to Embodiment 1 of the present invention;

FIG. 6 is a diagram showing an example of content of data base of operation procedure of system for supporting nuclear power plant operation according to Embodiment 1 of the present invention;

FIG. 7 is a diagram showing an example of display of operation procedure of system for supporting nuclear power plant operation according to Embodiment 1 of the present invention;

FIG. 8 is a diagram showing an example of operation confirmation screen of system for supporting nuclear power plant operation according to Embodiment 1 of the present invention;

FIG. 9 is a flow sheet illustrating the procedure of operation confirmation process a system for supporting nuclear power plant operation according to Embodiment 1 of the present invention;

FIG. 10 is a diagram illustrating the transition of displayed images of a system for supporting nuclear power plant operation according to Embodiment 1 of the present invention;

FIG. 11 is a diagram showing an example of operation confirmation screen of system for supporting nuclear power plant operation according to Embodiment 2 of the present invention; and

FIG. 12 is a flow sheet illustrating the procedure of operation confirmation process a system for supporting nuclear power plant operation according to Embodiment 2 of the present invention.

### DETAILED DESCRIPTION OF THE INVENTION

### First Embodiment

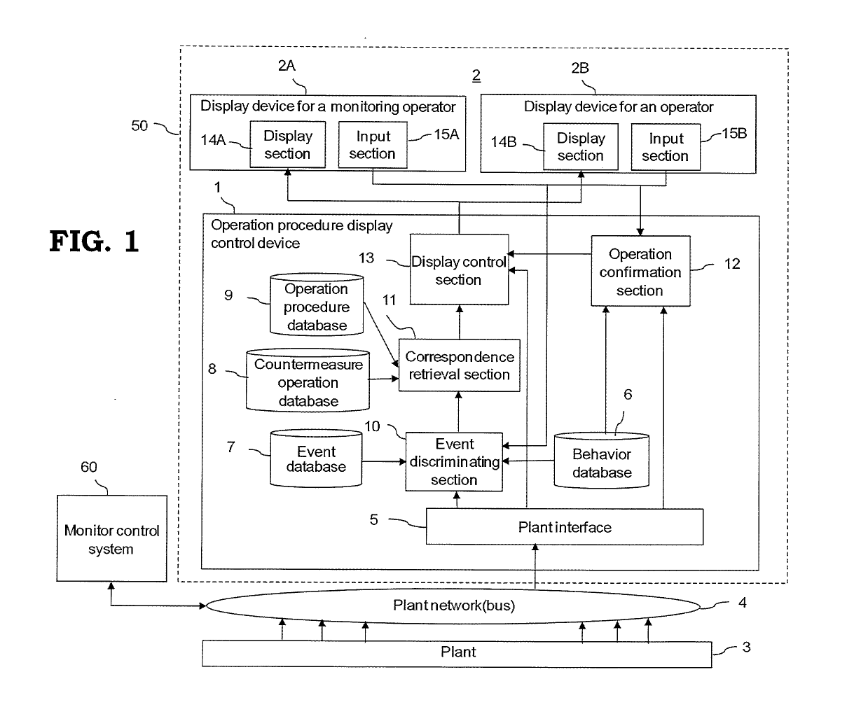

FIG. 1 is a block diagram illustrating a configuration of system for supporting nuclear power plant operation according to Embodiment 1 of the present invention. In FIG. 1, numeral 1 indicates an operation procedure display control device, numeral 2A indicates a display device for a monitoring operator and numeral 2B indicates a display device for an operator. Combining the display device for a monitoring operator 2A and the display device for an operator 2B, the display device may be indicated as a display device 2. In a large-scale plant such as a nuclear power plant, operation procedures are generally displayed for both a monitoring operator and an operator who actually executes a plant operation. Consequently, two display devices are provided. In the display devices 2A and 2B, display sections 14A and 14B, and touch panel type input sections 15A and 15B integrated with the display sections are provided, respectively. The input sections 15A and 15B are for a monitoring operator and an operator to input for operation and confirmation. The input sections 15A and 15B do not have to be a touch panel type but may be input equipment such as a mouse. Numeral 3 indicates a nuclear power plant and numeral 4 indicates a plant network (bus). The state of various kinds of sensors that are provided in the nuclear power plant and that of operation equipment is captured as a plant data into the operation procedure display control device 1 through the plant network 4. Numeral 5 indicates a plant interface for capturing the plant data into the operation procedure display control device 1. The operation procedure display control device 1 includes a behavior database 6, an event database 7, a countermeasure operation database 8 and an operation procedure database 9. Numeral 10 indicates an event discriminating section that discriminates an event that occurs on a plant referring to the behavior database 6 and the event database 7 based on a plant data that is captured from the plant interface 5. Numeral 11 indicates a countermeasure retrieval section, wherein a countermeasure operation corresponding to an event that is discriminated by the event discrimination section 10 is retrieved from the countermeasure operation database 8, and an operation procedure corresponding to a countermeasure operation is extracted from the operation procedure database 9. Numeral 12 indicates an operation confirmation section, wherein the information of operation confirmation based on input from an input section is output. Numeral 13 indicates a display control section, wherein an operation procedure that is extracted by the countermeasure retrieval section 11 is received, and an operation procedure, a necessary plant data or a displayed image for operation confirmation is displayed.

Here, the system for supporting nuclear power plant operation 50 according to the Embodiment 1 of the present invention is a combination of the operation procedure display control device 1 and the display device 2. Further, a monitoring control system 60 is connected to the plant network 4 as a system for operating, monitoring and controlling a nuclear power plant. The monitoring control system 60 includes a plurality of control devices, display sections and input sections, however, description of details of them is omitted.

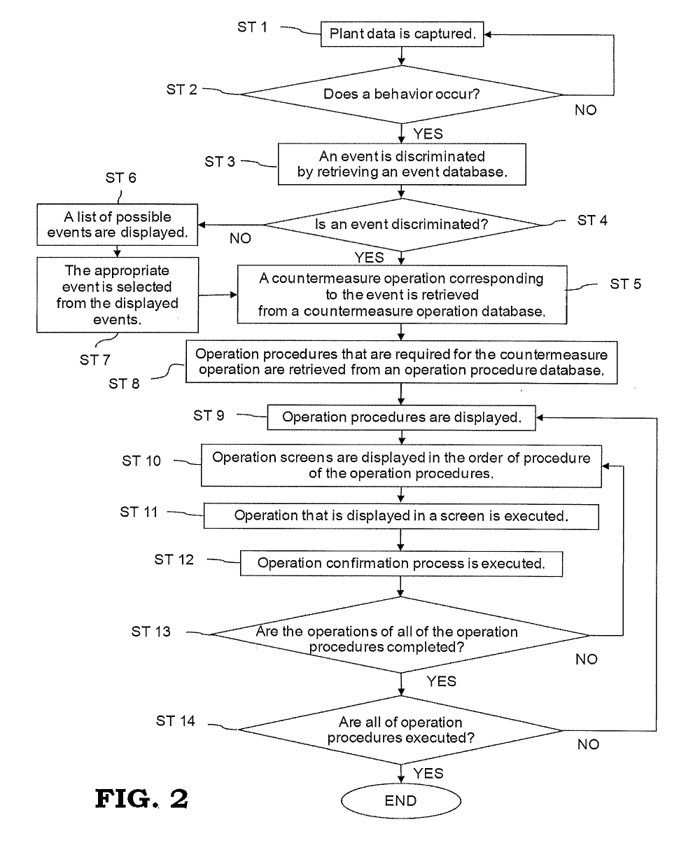

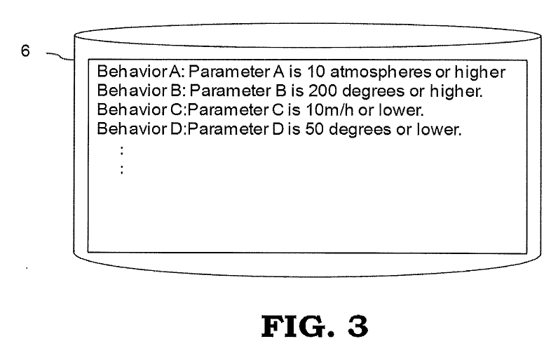

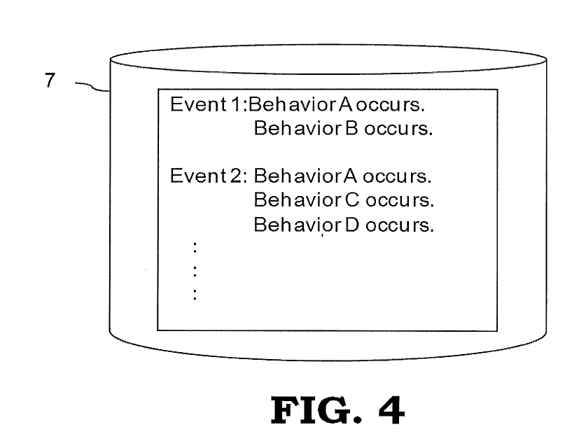

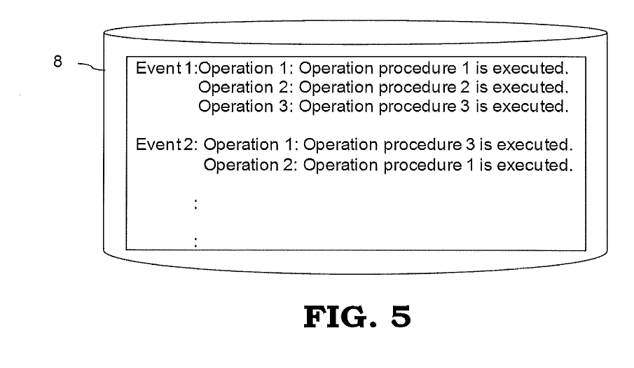

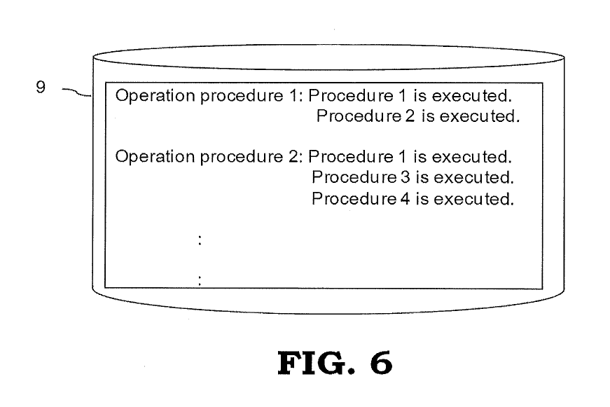

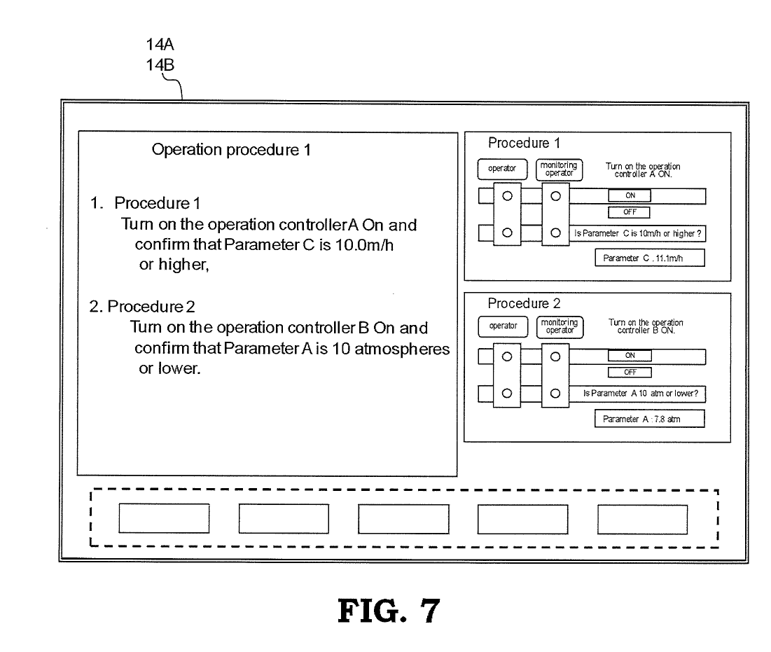

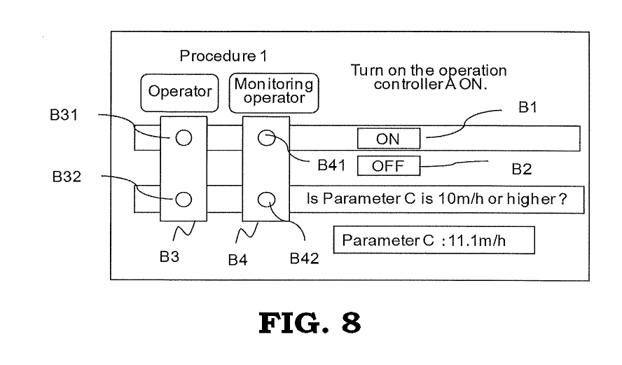

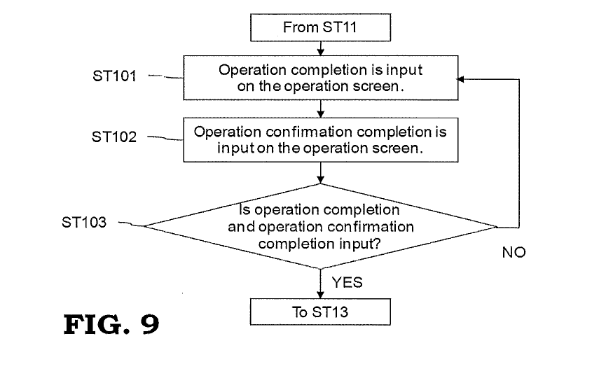

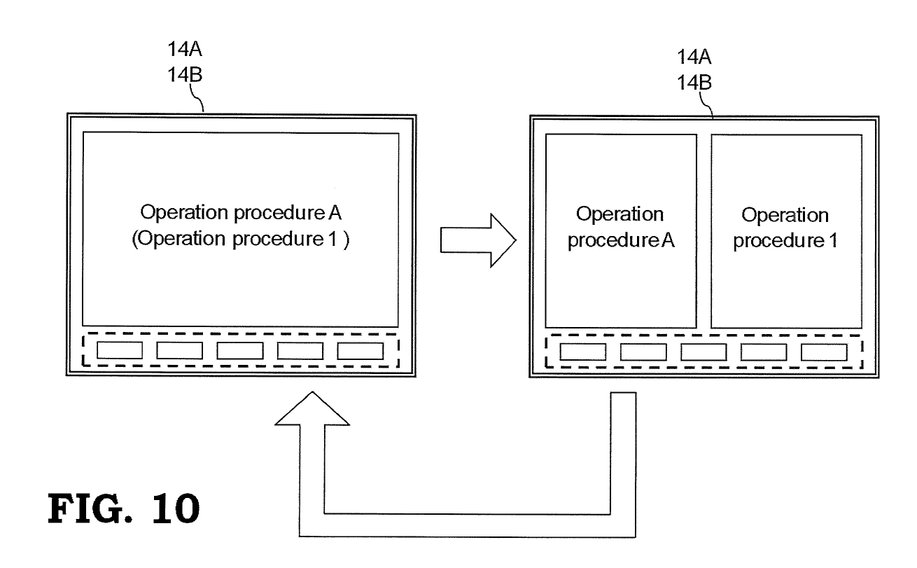

Next, operation of the system for supporting nuclear power plant operation shown in FIG. 1 will be described referring to FIGS. 2 to 10. FIG. 2 is a flow chart illustrating the outline of operation of a system for supporting nuclear power plant operation according to Embodiment 1 of the present invention; FIG. 3 is a diagram showing an example of content of the behavior database 6, FIG. 4 is a diagram showing an example of content of the event database 7, FIG. 5 is a diagram showing an example of content of the countermeasure operation database 8 and FIG. 6 is a diagram showing an example of content of the operation procedure manual database 9. FIG. 7 is a diagram showing an example of a displayed image of an operation procedure, FIG. 8 is a diagram showing an example of an operation confirmation screen, FIG. 9 is a flow chart illustrating the procedure of operation confirmation and FIG. 10 is a diagram illustrating an example of the transition of displayed images.

In a system for supporting a nuclear power plant operation according to the Embodiment 1 of the present invention, plant data is constantly captured via the plant interface 5 at a regular time interval (ST1). In the event discriminating section 10, the captured plant data is compared with data in the behavior database 6 so as to discriminate whether a behavior occurs or not (ST2). When a plant normally operates, the event discriminating section 10 judges that a behavior does not occur and the process is proceeded to the branch of NO, and a plant data at the next point is captured (ST1). As shown in FIG. 3, the behavior database 6 stores threshold values at which individual parameters of plant data become abnormal. For example, in a case where a pressure of a piping should be less than 10 atmosphere pressure, an output from a pressure sensor that measures the pressure of the piping part is captured as plant data and the captured data is defined as a parameter A, and as shown in FIG. 3, “When a parameter A is 10 atmosphere pressure or higher” is an abnormal state, and the above-mentioned behavior is stored as “behavior A” in the behavior database 6. In the step ST2, the captured plant data is compared with a value of behavior that is stored in the behavior database 6 so as to judge whether a behavior occurs or not.

In a case where an event that requires an operation in a plant occurs, in general, plural behaviors corresponding to the event occur. An operator in a control room can not confirm the event itself, and plural behaviors are informed via the monitoring control system 60. In the event database 7, a group of events that occur during the operation of plant and a plurality of behaviors that are informed to the monitoring control system 60 when individual events occur are stored as a set. Regarding the events and behaviors, in designing a plant and a system, expected events and behaviors corresponding to the events are sort out and are input preliminarily. For example, when it is supposed that “Behavior A occurs.” and “Behavior B occurs.” in a case where “Event 1” occurs, “Behavior A occurs.” and “Behavior B occurs.” are input to be stored as “Event 1” in the event database 7 as shown in FIG. 4.

In the step ST2, when the system discriminates the occurrence of behavior in a plant, the event data base 7 is retrieved based on the discriminated behavior so as to discriminate the event (ST3). For example, in the step ST2, in a case where the system discriminates such that “Behavior A occurs.” and “Behavior B occurs.” the event data base 7 in FIG. 4 is retrieved so as to discriminate such that “Event 1” occurs. As above-mentioned, in a case where an event that occurs could be discriminated, the procedure goes to step ST5.

There are various kinds of plant events, therefore, a behavior that is discriminated to occur may not exactly correspond with an event database. In the step ST2, in a case where the system discriminates the occurrence of a behavior and the event data base 7 is retrieved so as to find out such that there is not an event that exactly corresponds with the event data base 7, the procedure goes to the step ST6. For example, in a case where the system discriminates the occurrence of “Behavior A” and “Behavior C”, a case in which an event where only two behaviors of “Behavior A” and “Behavior C” occur is not stored in the event database 7 is supposed. In this case, in the step ST3, the event cannot be discriminated, therefore, the procedure goes to a branch of NO in the step ST4, that is, the procedure goes to the step ST6. In the step ST6, the display sections 14A and 14B displays a list of possible events. For example, events that include both “Behavior A occurs.” and “Behavior C occurs.” are displayed as a list of possible events. A monitoring operator or an operator considers these behaviors and discriminates which event occurs among the events that are displayed. Then, the monitoring operator or the operator selects the event that is discriminated to occur and input the discriminated event from the input section 15A or 15B. Input is executed from the touch panel, for example, an event section displayed as a list is the touch panel.

Further, as a list that displays a case that does not have an agreement rate of 100% to the event data base 7, the name of event having high agreement rate and its agreement rate may be displayed. For example, as above-mentioned, it may display such that in a case where the system discriminates the occurrence of “Behavior A” and “Behavior C”, an event 2 shown in FIG. 4 has the agreement rate of two-thirds, that is “Event 2: agreement rate 67%”. By this display, in a case where an event does not have an agreement rate of 100% to the data base, load of an operator regarding the estimation of event can be decreased.

Next, in the countermeasure retrieval section 11, a countermeasure operation corresponding to the event that is discriminated in the step ST3 or the event that is selected in the step ST7 is retrieved from the countermeasure operation database 8 (ST5). In the countermeasure operation database 8 as shown in FIG. 5, an event and an operation corresponding to the event are stored as a pair. Therefore, when an event is specified, a countermeasure operation corresponding to the event can be found out by retrieving the database. As shown in FIG. 5, in the countermeasure operation database 8, an operation procedure to be executed as a countermeasure operation is sequentially stated. Consequently, among the operation procedures that are stated in the countermeasure operation that is found out by retrieving the database, the operation procedure that should be executed as a first priority is extracted from the operation procedure database 9, the operation procedures that are extracted are displayed in the display sections 14A and 14B by the display control section 13(ST9).

In the operation procedure database 9, the operation procedure that is stated in the same way as that of written document is stored as a screen display data. As shown in FIG. 6, the procedure of the operation procedure is stated. In the operation procedure database 9, operation screens for every procedure are stored, the display control section 13 displays an operation procedure and an operation screen in the display sections 14A and 14B in order of the operation procedure (ST10).

An example of operation procedure is shown in FIG. 7. In a case where the operation procedure gives instructions to execute the procedure 1 and then to execute the procedure 2, a screen of operation to be executed by the procedure 1 (operation screen) and a screen of operation to be executed by the procedure 2 (operation screen) are displayed. An operator executes an operation that is displayed on an operation screen (ST11). After the operator executes the operation, the operator and a monitoring operator execute an operation confirmation process (ST12).

FIG. 8 is an enlarged view of an operation screen, and FIG. 9 is a flow chart showing the operation confirmation process in the step ST12. As an operation screen, the same screen is displayed in the display section 14A of the display device for a monitoring operator 2A and in the display section 14B of the display device for an operator 2B. An operation screen also functions as a confirmation screen. In an example shown in FIG. 8, the procedure 1 is “to turn ON an operation controller A and confirm that the parameter C is 10 m/h or higher. In this case, ON-OFF buttons B1 and B2 of the operation controller A that should be operated are displayed as a touch panel type so as to operate the controller, as an operation screen. In the state where the OFF button is turned on, when an operator touches the ON button B1, the operation controller A is turned ON, both an ON button that is displayed in the display section 14A of the display device for an operator 2B and an ON button of the display device for a monitoring operator 2A are lighted up. Further, in the left side of the ON buttons, operation confirmation buttons B3 and B4 are displayed. The operation confirmation button B3 is for an operator and the operation confirmation button B4 is for a monitoring operator. After an operator confirms that the ON button is lighted up, the operator touches an ON button confirmation button B31 in the confirmation button B3 so as to input the completion of the operation (ST101). By touching the confirmation button B31, the confirmation button 331 is lighted up. After a monitoring operator confirms that the ON button B1 of the operation controller A and the confirmation button 1331 that is touched by the operator are lighted up, the monitoring operator touches a confirmation button 341 (ST102). By touching the confirmation button B41, the confirmation button B41 is lighted up.

The procedure 1 includes a procedure such that “confirming that the parameter C is 10 m/h or more”. Therefore, as shown in FIG. 9, an operation screen displays the parameter C that is input in the operation confirmation section 12 via the plant interface 5. Further, an item, “parameter C is 10 m/h or higher” is displayed and the confirmation button for an operator B32 and the confirmation button for a monitoring operator B42 are displayed on the left of the item. An operator confirms such that the parameter C that is displayed is 10 m/h or more and then touches the confirmation button B32 as an action of inputting the operation completion (ST101) on an operation screen. When the confirmation button B32 is touched, it is lighted up. A monitoring operator confirms such that the confirmation button B32 is lighted up and the parameter C is 10 m/h or more, and then touches the confirmation button B42 as an action of inputting the operation completion (ST102) on an operation screen. When the confirmation button B42 is touched, it is lighted up.

Further, regarding some kinds of parameters and operation controllers to be confirmed, there are some cases in which message can not be displayed in the display sections 14A and 14B or message can not be input from the input sections 15A and 15B. For example, in a case where input is performed to a device regarding protection or safety of atomic reactor, it is required to input from the safety monitor control system. In this case, according to an operation procedure that is displayed in the display sections 14A and 14B, an operator confirms the parameter corresponding to the monitor control system 60 and inputs items for an operation controller, and touches the confirmation buttons B31 and 332. Further, a monitoring operator confirms a parameter corresponding to the monitoring control system 60 in the same way as that of the operator, and touches the confirmation buttons B41 and 342.

In order to prevent the human error of a monitoring operator, in a case where a display of confirmation button for an operator is different from that of confirmation button for a monitoring operator, the screen that gives a warning to the operator and the monitoring operator may be displayed so as to determine whether the procedure should be restored to the beginning (ST103) or the procedure executes forcibly.

As above-mentioned, when the operation completion and the operation confirmation completion are input, the operation confirmation process, that is, the step ST12 is completed. Therefore, a series of the procedure 1 is completed, so the procedure goes to the step ST13. If all operations that are stated in the operation procedure are not completed, the procedure goes back to the step ST10, and regarding the remaining operation procedure, from the step ST10 to the step ST13, the operation is repeatedly performed. When all operations (procedure) that are stated in the operation procedure are completed, the system discriminates whether there is the operation procedure that is not performed or not (ST14). Then, regarding the operation procedure that is not performed, from the step ST9 to the step ST14, the operation is sequentially executed. Then, when all operation procedures regarding the event are completed, the routine regarding the event is completed.

Further, in displaying operation procedures in the step ST9, for example, before an event occurs, if the operation procedure A is displayed as shown in the left screen in FIG. 10, when an event occurs, as shown in the right screen in FIG. 10, the operation procedure 1 that is retrieved by the countermeasure retrieval section 11 and the operation procedure A that was displayed before the event occurs are displayed adjacent to each other. In the screen, when, and an operator judges such that the display of the operation procedure A is unnecessary since the operation procedure 1 that was retrieved by the countermeasure retrieval section 11 is useful, by changing the screen of the operation procedure under display by screen operation, the display of the operation procedure A is cancelled, and only the operation procedure 1 is displayed. According to the above-mentioned operation, an operator can refer to the part of the operation procedure that the operator wants to refer and the part of the operation procedure that is retrieved by the system corresponding to the plant state at the same time.

As above-mentioned, in the system for supporting nuclear power plant operation according to the Embodiment 1 of the present invention, an operation procedure corresponding to an event is displayed and an operation confirmation button for operation confirmation is displayed as an operation screen in the order of the procedure that is stated in the operation procedure. Therefore, both of an operator and a monitoring operator operate while confirming the operation by a confirmation button that is displayed in parallel with the procedure. Consequently, operation confirmation can be surely performed and an operation procedure based on the safety provision can be surely executed.

### Second Embodiment

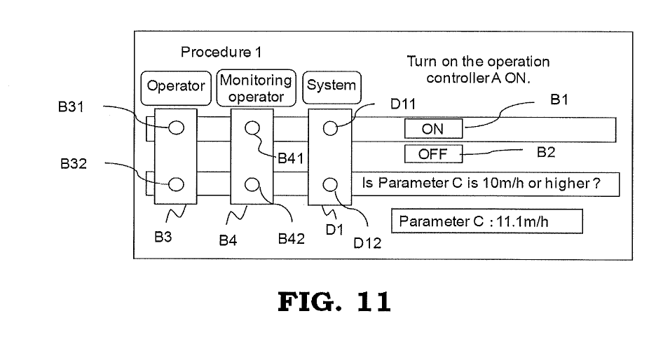

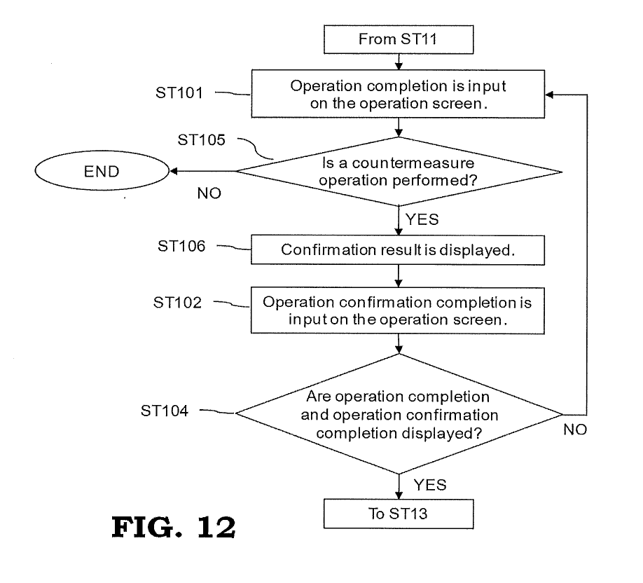

FIGS. 11 and 12 are diagrams describing the system for supporting nuclear power plant operation according to Embodiment 2 of the present invention. In Embodiment 2, in addition to Embodiment 1, operation confirmation is executed also in a system for supporting nuclear power plant operation. Entire configuration is the same as that shown in FIG. 1 and entire flow is the same as that shown in FIG. 2, however, an operation confirmation process in the step ST12 in FIG. 2 is different from that of Embodiment 1.

Hereinafter, an operation of operation confirmation process in Embodiment 2 of the present invention will be described referring to FIGS. 11 and 12. FIG. 11 is a diagram showing an operation screen and FIG. 12 is a flowchart illustrating a procedure of the step ST12. As an operation screen, the same screens are displayed in the display section 14A in the display device for a monitoring operator 2A and in the display section 14B in the display device for an operator 2B. An operation screen also functions as an operation confirmation screen. In an example shown in FIG. 11, the procedure 1 indicates such that “Turn on the operation controller A and confirm that the parameter C is 10 m/h or higher”. In this case, ON-OFF buttons B1 and B2 of the operation controller A that should be operated are displayed as a touch panel type so as to operate the controller, as an operation screen. In the state where the OFF button is turned on, when an operator touches the ON button B1, the operation controller A is turned ON, both an ON button that is displayed in the display section 14A of the display device for an operator 2B and an ON button that is displayed in the display section 14B of the display device for a monitoring operator 2A are lighted up. Further, in the left side of the ON buttons, operation confirmation buttons B3 and B4 are displayed. The operation confirmation button B3 is for an operator and the operation confirmation button B4 is for a monitoring operator. In the side of the operation confirmation buttons B3 and B4, a confirmation display D1 having the same design as that of the confirmation buttons B3 and B4 is displayed. After an operator confirms that an ON button is lighted up, the operator touches an ON button confirmation button B31 in the confirmation button B3 so as to input the completion of the operation (ST101). By touching the confirmation button B31, the confirmation button B31 is lighted up. On the other hand, the system confirms whether a countermeasure operation in the procedure 1 is performed or not when it receives the message such that the confirmation button B31 is touched by the operator (ST105). That is, when the state of the operation controller A is captured via a plant interface and the state in which the operation controller A is on is confirmed, a display D11 of confirmation display D1 is lighted up (ST106). In a case where the system can not confirm such that the operation controller A is ON in the step ST105, the screen that gives a warning to the operator and the monitoring operator is displayed so as to restore the procedure to the beginning or to execute the procedure forcibly, that is, to finish the routine. After a monitoring operator confirms that the ON button B1 of the operation controller A and the confirmation button B31 that is touched by the operator are lighted up, the monitoring operator touches the confirmation button B41 (ST102). By touching the confirmation button B41, the confirmation button B41 is lighted up.

The procedure 1 includes a procedure such that “confirming that the parameter C is 10 m/h or higher”. Therefore, as shown in FIG. 11, the parameter C is displayed in an operation screen. Further, an item, “parameter C is 10 m/h or higher” is displayed and the confirmation button for an operator B32 and the confirmation button for a monitoring operator B42 are displayed on the left of the item. After an operator confirms such that the parameter C that is displayed is 10 m/h or higher, the operator touches the confirmation button B32 as an operation of inputting the operation completion (ST101) on an operation screen. When the confirmation button B32 is touched, it is lighted up. When the system receives the message such that the confirmation button B32 for an operator is touched, it confirms such that the parameter C is 10 m/h or higher referring to the plant data via a plant interface, and then the display D12 of the confirmation display D1 is lighted up (ST106). In a case where the system can not confirm such that the parameter C is 10 m/h or higher in the step ST105, the screen that gives a warning to the operator and the monitoring operator is displayed so as to restore the procedure to the beginning or to execute the procedure forcibly, that is, to finish the routine. After a monitoring operator confirms such that the confirmation button B32 is lighted up and the parameter C is 10 m/h or higher, the monitoring operator touches the confirmation button B42 as an operation of inputting (ST102) the operation confirmation completion on an operation screen. When the confirmation button B42 is touched, the confirmation button is lighted up and the procedure goes to the step ST13.

Further, the confirmation buttons B41 and 1342 are for the monitoring operators to make the final decision in operation execution, therefore, the confirmation buttons B41 and B42 can be input by decision of the monitoring operator without the displays of D11 and D12 that are the confirmation displays made by the system. However, in order to prevent the human error of a monitoring operator, in a case where the display of confirmation button for an operator is different from that of confirmation button for the monitoring operator, the screen that gives a warning to the operator and the monitoring operator may be displayed so as to determine whether the procedure should be restored to the beginning or the procedure should execute forcibly (ST104).

If all operations that are stated in the operation procedure are not completed, the procedure goes back to the step ST10, and regarding the remaining operation procedures, from the step ST10 to the step ST13, the operation is repeatedly executed. When all operations (procedures) that are stated in the operation procedure are completed, the system discriminates whether there is the operation procedure that is not executed or not (ST14). Then, regarding the operation procedure that is not executed, from the step ST9 to the step ST14, the operation is sequentially executed. Then, when all operation procedures regarding the event are completed, the routine regarding the event is finished.

As above-mentioned, in the system for supporting nuclear power plant operation according to the Embodiment 2 of the present invention, an operation procedure corresponding to an event is displayed and an operation confirmation button for operation confirmation is displayed as an operation screen in the order of the procedure that is stated in the operation procedure. Therefore, both an operator and a monitoring operator operate while confirming the operation by a confirmation button that is displayed in parallel with the procedure. At the same time, the system also confirms the operation confirmation and displays the result and the above-mentioned confirmation button in parallel. Consequently, operation confirmation can be surely performed and an operation procedure based on the safety provision can be surely executed.

What is claimed is:

1. A system for supporting a nuclear power plant operation including:
a display section in which plant data of the nuclear power plant is captured from a plant interface via a network so as to display an operation procedure of plant corresponding to the plant data;
an event data base that stores events corresponding to behaviors of the plant data;
a countermeasure operation database that stores operations corresponding to the events;
an operation procedure database that stores operation procedures that are required for the corresponding operations;
an event discriminating section in which an event that occurs in the nuclear power plant is retrieved from the event database so as to discriminate based on a behavior of plant data that is captured from the plant interface;
a countermeasure retrieval section in which a countermeasure operation is retrieved from the countermeasure operation database based on an event that is discriminated by the event discriminating section;
a display control section in which an operation procedure that is required for performing a countermeasure operation and is retrieved by the countermeasure retrieval section is sequentially read out so as to display the operation procedure on the display device; and
an operation confirmation section which judges whether the countermeasure operation that is retrieved by the countermeasure retrieval section is completed or not.

2. The system for supporting nuclear power plant operation according to claim 1,
wherein the operation confirmation section determines the completion of the countermeasure operation
by the input information of operation completion from an input section,
and the input information of operation confirmation completion from the input section,
and judging whether the countermeasure operation is actually performed or not based on the information of the state of device in a plant that is captured from a plant interface.

3. The system for supporting nuclear power plant operation according to claim 2, wherein the display control section controls the display section to display
a display of an operation completion by input of operation completion,
a display of operation confirmation by input of operation confirmation completion,
and a display of the result that is obtained by judging the actual execution of the countermeasure operation,
in parallel.
